(19) United States
(12) Patent Application Publication
(10) Pub. No.: US 2025/0011225 A1
(43) Pub. Date: Jan. 9, 2025

(54) METHOD FOR PLANARIZING TEXTURED GLASS SUBSTRATES USING A SILICON OXIDE COATING DEPOSITED VIA INKJET PRINTING AND TEXTURED GLASS SUBSTRATES WITH SUCH COATINGS

(71) Applicant: CORNING INCORPORATED, CORNING, NY (US)

(72) Inventors: Philip Simon Brown, Big Flats, NY (US); Yuhui Jin, Painted Post, NY (US); Mandakini Kanungo, Ithaca, NY (US)

(21) Appl. No.: 18/712,424

(22) PCT Filed: Nov. 18, 2022
(86) PCT No.: PCT/US2022/050348

§ 371 Date: May 22, 2024

Related U.S. Application Data
(60) Provisional application No. 63/283,888, filed on Nov. 29, 2021.

(51) Int. Cl. C03C 17/23

(52) U.S. Cl. CPC C03C 17/23; C03C 2218/119; C03C 2218/31; C03C 2218/32

(57) ABSTRACT

An article includes a glass, glass-ceramic, or ceramic substrate with at least one surface that has a textured region. The textured region includes a plurality of topographical features that define voids opening towards the surface. The article further includes a coating that comprises a cured silicon oxide (SiOₓ) material positioned in a pattern on at least a portion of the textured region to fill the voids at least partially. The cured SiOₓ material planarizes the textured region and modifies surface attributes such as haze, distinctness-of-image (DOI), surface roughness, and abrasion performance. A method is disclosed for planarizing a textured surface by jetting a solution comprising a SiOₓ material and a solvent in a pattern on a portion of the textured surface. The SiOₓ solution is cured to form a coating comprising the cured SiOₓ material.

### CROSS REFERENCE TO RELATED APPLICATIONS

This application claims the benefit of priority under 35 U.S.C. § of U.S. Provisional Application No. 63/283,888, filed Nov. 29, 2021, the content of which is incorporated herein by reference in its entirety.

### FIELD

The present disclosure relates to textured articles and, more particularly, to methods for planarizing textured glass, glass-ceramic, or ceramic surfaces using a silicon oxide coating positioned via inkjet printing and to articles with textured surfaces comprising a silicon oxide coating.

### BACKGROUND

Textured glass, glass ceramic, and ceramic (collectively “glass” unless indicated otherwise) are used in many applications. In mobile consumer electronics, textured glass is sometimes used for anti-glare display covers and for anti-fingerprint and anti-slip non-display covers. Textured glass can be used for both front cover and back cover applications. These glass covers often contain both textured and non-textured areas that can serve various functions and provide aesthetic appearance. For example, a textured front cover of a device can include a non-textured portion that overlies a camera region of the device. Similarly, a textured back cover of a device can be decorated with a non-textured glossy logo.

Existing methods for forming a non-textured region within a textured region of a glass surface often include multiple steps. In some existing methods, the non-textured region is formed before formation of the textured region. Such methods can include the steps of applying a mask to a non-textured region of a glass surface, texturing the remaining, non-masked area of the glass surface, and then removing the mask to expose the non-textured region within the textured region. In other existing methods, the non-textured region is formed after formation of the textured region. Such methods can include the steps of texturing a surface of a glass substrate and then using mechanical processes, such as grinding and/or polishing, to remove the texture from certain areas of the textured surface to form the non-textured region. These strategies pose some challenges. First, the multi-step process in each case can be expensive in terms of processing materials, labor, and processing equipment. Second, product yield can be reduced since accurate pre-alignment of the non-textured portion on full sheet glass during the masking step can be difficult.

Consequently, it would be advantageous to provide a method and an article formed from such a method that overcome these challenges.

### SUMMARY

A first aspect of the present disclosure includes an article, comprising: a glass, glass-ceramic, or ceramic substrate having a surface with a textured region, the textured region comprising a plurality of topographical features that define voids opening towards the surface; and a coating comprising a cured silicon oxide (SiOₓ) material positioned in a pattern on at least a portion of the textured region to fill the voids at least partially.

A second aspect of the present disclosure according to the first aspect, wherein the coating completely fills at least some of the voids within the pattern.

A third aspect of the present disclosure according to the first aspect, wherein the coating completely fills all the voids within the pattern.

A fourth aspect of the present disclosure according to the first aspect, wherein the coating planarizes the textured region within the pattern.

A fifth aspect of the present disclosure according to the first aspect, wherein a volume of the coating is less than a volume of the voids within the pattern.

A sixth aspect of the present disclosure according to the first aspect, wherein a volume of the coating is approximately equal to a volume of the voids within the pattern.

A seventh aspect of the present disclosure according to the first aspect, wherein a volume of the coating is greater than a volume of the voids within the pattern.

An eighth aspect of the present disclosure according to any one of the first through seventh aspects, wherein the pattern is continuous across the surface such that the coating forms a single, interconnected coating region.

A ninth aspect of the present disclosure according to any one of the first through seventh aspects, wherein the pattern is discontinuous across the surface such that the coating forms a plurality of discrete coating regions spaced-apart from one another.

A tenth aspect of the present disclosure according to any one of the first through ninth aspects, wherein the coating comprises exactly one layer of the cured SiOₓ material.

An eleventh aspect of the present disclosure according to any one of the first through ninth aspects, wherein the coating comprises n layers of the cured SiOₓ material, where n is a positive integer and 1<n<15.

A twelfth aspect of the present disclosure according to any one of the first through eleventh aspects, wherein a transmission haze of the substrate through the portion of the textured region with the coating is less than the transmission haze through a reference portion of the textured region without the coating.

A thirteenth aspect of the present disclosure according to the twelfth aspect, wherein the transmission haze through the coated portion is at least 20% less than the transmission haze through the reference portion.

A fourteenth aspect of the present disclosure according to the twelfth aspect, wherein the transmission haze through the coated portion is at least 70% less than the transmission haze through the reference portion.

A fifteenth aspect of the present disclosure according to any one of the first through fourteenth aspects, wherein a distinctiveness of image (DOI) of the substrate at the portion of the textured region with the coating is greater than the DOI at a reference portion of the textured region without the coating.

A sixteenth aspect of the present disclosure according to the fifteenth aspect, wherein the DOI at the coated portion is at least 50% greater than the DOI at the reference portion.

A seventeenth aspect of the present disclosure according to the fifteenth aspect, wherein the DOI at the coated portion is at least 90% greater than the DOI at the reference portion.

An eighteenth aspect of the present disclosure according to the fifteenth aspect, wherein the DOI at the coated portion is greater than or equal to 95%.

A nineteenth aspect of the present disclosure according to any one of the first through eighteenth aspects, wherein an abrasion performance of the substrate at the portion of the textured region with the coating is greater than the abrasion performance at a reference portion of the textured region without the coating.

A twentieth aspect of the present disclosure according to the nineteenth aspect, wherein the abrasion performance at the coated portion shows less visible scratch compared to the abrasion performance at the reference portion.

A twenty first aspect of the present disclosure according to any one of the first through twentieth aspects, wherein the SiOₓ material includes silicon-oxygen compounds represented by the formula SiOₓ, where 0.5≤x≤3.

A method of planarizing a textured article according to a twenty second aspect, comprising: jetting, in a stable manner from a printhead, a solution comprising a silicon oxide (SiOₓ) material and a solvent on a glass, glass-ceramic, or ceramic substrate having a surface with a textured region, the solution jetted in a pattern on a portion of the textured region.

A twenty third aspect of the present disclosure according to the twenty second aspect, wherein the solution is configured to have a target viscosity and a target surface tension that enable the stable jetting from the printhead.

A twenty fourth aspect of the present disclosure according to the twenty third aspect, wherein the target viscosity is in a range from about 8 cP to about 12 cP and the target surface tension is in a range from about 25 mN/m to about 32 mN/m.

A twenty fifth aspect of the present disclosure according to any one of the twenty second through twenty fourth aspects, wherein the SiOₓ material includes silicon-oxygen compounds represented by the formula SiOₓ, where 0.5≤x≤3 or compounds configured to be converted to the silicon-oxygen compounds represented by the formula SiOₓ via curing.

A twenty sixth aspect of the present disclosure according to the twenty fifth aspect, wherein the SiOₓ material is hydrogen silsesquioxane (HSQ) and the concentration of HSQ is from about 2.5 wt % to about 5 wt %, based on a total weight of the solution.

A twenty seventh aspect of the present disclosure according to any one of the twenty second through twenty sixth aspects, wherein the solvent is selected from the group consisting of alcohols, aromatic hydrocarbons, alkanes, ketones, esters, glycol ethers, siloxanes, fluorinated solvents, perfluoroalkane, fluoroether, and combinations thereof.

A twenty eighth aspect of the present disclosure according to any one of the twenty second through twenty seventh aspects, wherein jetting the solution from the printhead comprises moving at least one of the substrate and the printhead relative to the other of the substrate and the printhead.

A twenty ninth aspect of the present disclosure according to any one of the twenty second through twenty eighth aspects, wherein the solution is jetted in the pattern with a resolution of at least 600 dpi.

A thirtieth aspect of the present disclosure according to any one of the twenty second through twenty eighth aspects, wherein the solution is deposited in the pattern with a resolution of at least 1200 dpi.

A thirty first aspect of the present disclosure according to any one of the twenty second through thirtieth aspects, further comprising setting a parameter of the printhead to enable stable jetting of the solution from the printhead, the parameter including one or more of a peak voltage, a printhead temperature, and a drive waveform.

A thirty second aspect of the present disclosure according to the thirty first aspect, wherein one or more of the peak voltage is approximately 20V, the printhead temperature is approximately 35° C., and the drive waveform is a standard waveform.

A thirty third aspect of the present disclosure according to any one of the twenty second through thirty second aspects, further comprising heating the substrate to a target temperature before jetting the solution on the portion of the textured region.

A thirty fourth aspect of the present disclosure according to the thirty third aspect, wherein the target temperature of the substrate is at least 20° C.

A thirty fifth aspect of the present disclosure according to any one of the twenty second through thirty fourth aspects, wherein the solution is jetted in exactly one layer throughout the pattern.

A thirty sixth aspect of the present disclosure according to any one of the twenty second through thirty fourth aspects, wherein the solution is jetted in n layers throughout the pattern, where n is a positive integer and 1<n<15.

A thirty seventh aspect of the present disclosure according to any one of the twenty second through thirty sixth aspects, further comprising curing the solution after jetting to form a coating comprising the cured SiOₓ material.

A thirty eighth aspect of the present disclosure according to the thirty sixth aspect, further comprising curing the solution after jetting to form a cured SiOₓ material, the solution cured after jetting each layer of the n layers.

A thirty ninth aspect of the present disclosure according to the thirty sixth aspect, further comprising curing the solution after jetting to form a cured coating comprising cured SiOₓ material, the solution cured after jetting all the n layers.

A fortieth aspect of the present disclosure according to any one of the thirty seventh through thirty ninth aspects, wherein curing the solution comprises thermal curing.

A forty first aspect of the present disclosure according to the fortieth aspect, wherein the thermal curing is performed in a range from about 250° C. to about 600° C.

A forty second aspect of the present disclosure according to any one of the thirty seventh through thirty ninth aspects, wherein curing the solution comprises plasma curing.

A forty third aspect of the present disclosure according to the forty second aspect, wherein the plasma curing is performed with a catalyst.

A forty fourth aspect of the present disclosure according to the forty second aspect, wherein the plasma curing is performed without a catalyst.

### BRIEF DESCRIPTION OF THE DRAWINGS

FIG. 1 is a top perspective view of an article comprising a glass, glass-ceramic, or ceramic substrate with a textured surface and a silicon oxide (SiOₓ) coating positioned in a pattern on a portion of the textured surface;

FIG. 2 is a section cut of the article of FIG. 1 along a line 2-2 passing only through an uncoated portion of the textured surface:

FIG. 3 is an enlarged detail view of the uncoated portion of the textured surface shown in FIG. 2;

FIG. 4 is a section cut of the article of FIG. 1 along a line 4-4 passing through a coated portion of the textured surface;

FIGS. 5 and 6 are enlarged detail views of the coated portion of the textured surface shown in FIG. 4 with the coated portion comprising a partially self-leveling coating;

FIGS. 7 and 8 are enlarged detail views of the coated portion of the textured surface shown in FIG. 4 with the coated portion comprising a self-leveling coating

FIG. 9 is a flow chart showing embodiments of a method of forming the article of FIG. 1;

FIGS. 10-13 are a series of top perspective representations depicting aspects of the method of FIG. 9;

FIG. 14 is a top perspective view of a glass, glass-ceramic, or ceramic substrate with a textured surface and a plurality of SiOₓ coating subregions each positioned in a pattern on a portion of the textured surface;

FIG. 15 is an image overlay of a plurality of still images of a single drop of the SiOₓ solution jetted from a printhead to illustrate stable jetting of the SiOₓ solution from the printhead;

FIG. 16 is an image of a glass substrate with an anti-glare surface having 20% haze with a portion of the anti-glare surface (upper right corner) including a SiOₓ coating, the glass substrate overlaying a string of text to illustrate a reduction in haze over the SiOₓ coated portion of the glass substrate;

FIG. 17 is a boxplot illustrating percent haze reduction on anti-glare glass with 20% haze versus number of print passes for a SiOₓ coating;

FIG. 18 is a boxplot illustrating percent haze reduction on anti-glare glass with 40% haze versus number of print passes for a SiOₓ coating; and

FIG. 19 is an image showing results of an abrasion test, comparing the abrasion performance of an AG glass sample with a SiOₓ coated surface (left) and to the abrasion performance of an AG glass sample without a surface coating (right).

### DETAILED DESCRIPTION

For the purposes of promoting an understanding of the principles of the disclosure, reference will now be made to the embodiments illustrated in the drawings and described in the following written specification. It is understood that no limitation to the scope of the disclosure is thereby intended. It is further understood that the present disclosure includes any alterations and modifications to the illustrated embodiments and includes further applications of the principles disclosed herein as would normally occur to one skilled in the art to which this disclosure pertains.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein, unless defined elsewhere in association with specific terms or phrases, are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

Directional terms as used herein—for example up, down, right, left, front, back, top, bottom, above, below, and the like—are made only with reference to the figures as drawn and are not intended to imply absolute orientation.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

As used herein, the terms “article,” “glass-article,” “ceramic-article,” “glass-ceramics,” “glass elements,” “glass-ceramic article” and “glass-ceramic articles” may be used interchangeably, and in their broadest sense, to include any object made wholly or partly of glass and/or glass-ceramic material.

“Anti-glare,” “antiglare,” “AG,” or like terms refer to a physical transformation of light contacting the treated surface of an article, such as a display, of the disclosure that changes, or to the property of changing light reflected from the surface of an article, into a diffuse reflection rather than a specular reflection. In embodiments, the surface treatment can be produced by mechanical, chemical, electrical, and like etching methods, or combinations thereof. Anti-glare does not reduce the amount of light reflected from the surface, but only changes the characteristics of the reflected light. An image reflected by an anti-glare surface has no sharp boundaries. In contrast to an anti-glare surface, an anti-reflective surface is typically a thin-film coating that reduces the reflection of light from a surface via the use of refractive-index variation and, in some instances, destructive interference techniques.

“Haze” (also referred to as “transmission haze”) is a surface light scatter characteristic and refers to the percentage of light scattered outside an angular cone of 4.0° in accordance with ASTM procedure D1003. For an optically smooth surface, transmission haze is generally close to zero. Low haze can be desirable for applications requiring high display contrast, while high haze can be useful for optical designs having scattering, such as edge illumination, or for aesthetic reasons, such as reducing the “black hole” appearance of the display in the off state. The general preference for low versus high haze (and the acceptance of performance trade-offs) can be motivated by customer or end-user preferences, and their final application and use mode.

“Distinctness-of-reflected image,” “distinctness-of-image,” “DOI” or like term is defined by method A of ASTM procedure D5767 (ASTM 5767), entitled “Standard Test Methods for Instrumental Measurements of Distinctness-of-Image Gloss of Coating Surfaces.” In accordance with method A of ASTM 5767, glass reflectance factor measurements are made on the at least one roughened surface of the glass article at the specular viewing angle and at an angle slightly off the specular viewing angle. The values obtained from these measurements are combined to provide a DOI value. In particular. DOI is calculated according to equation (1):

$$DOI = [ 1 - \frac{{R}_{OS}}{{R}_{S}} ] \times 100 \qquad ( 1 )$$

where Rs is the relative amplitude of reflectance in the specular direction and Ros is the relative amplitude of reflectance in an off-specular direction. As described herein, Ros, unless otherwise specified, is calculated by averaging the reflectance over an angular range from 0.2° to 0.4° away from the specular direction. Rs can be calculated by averaging the reflectance over an angular range of +0.05° centered on the specular direction. Both Rs and Ros were measured using a goniophotometer (Rhopoint Instruments) that is calibrated to a certified black glass standard, as specified in ASTM procedures D523 and D5767. The goniophotometer uses a detector array in which the specular angle is centered about the highest value in the detector array. DOI was also evaluated using 1-side (black absorber coupled to rear of glass) and 2-side (reflections allowed from both glass surfaces, nothing coupled to glass) methods. The 1-side measurement allows the gloss, reflectance, and DOI to be determined for a single surface (e.g., a single roughened surface) of the glass article, whereas the 2-side measurement enables gloss, reflectance, and DOI to be determined for the glass article as a whole. The Ros/Rs ratio can be calculated from the average values obtained for Rs and Ros as described above. “20° DOI,” or “DOI 20°” refers to DOI measurements in which the light is incident on the sample at 20° off the normal to the glass surface, as described in ASTM D5767. The measurement of either DOI or common gloss using the 2-side method can best be performed in a dark room or enclosure so that the measured value of these properties is zero when the sample is absent.

For anti-glare surfaces, it is generally desirable that DOI be relatively low and the reflectance ratio (Ros/Rs) of eq. (1) be relatively high. This results in visual perception of a blurred or indistinct reflected image. In embodiments, the at least one roughened surface of the glass article has a Ros/Rs greater than about 0.1, greater than about 0.4, and, greater than about 0.8, when measured at an angle of 20° from the specular direction using the 1-side method measurement. Using the 2-side method, the Ros/Rs of the glass article at a 20° angle from the specular direction is greater than about 0.05. In embodiments, the Ros/Rs measured by the 2-side method for the glass article is greater than about 0.2, and greater than about 0.4. Common gloss, as measured by ASTM D523, is insufficient to distinguish surfaces with a strong specular reflection component (distinct reflected image) from those with a weak specular component (blurred reflected image). This can be attributable to the small-angle scattering effects that are not measurable using common gloss meters designed according to ASTM D523. The scale value obtained with the measuring procedures of ASTM D5767 range from 0 to 100 with a value of 100 representing perfect DOI (image clarity).

“Roughness,” “surface roughness (Ra),” or like terms refer to, on a microscopic level or below, an uneven or irregular surface condition, such as an average root mean squared (RMS) roughness or RMS roughness described below.

“ALF” or “average characteristic largest feature size” or like terms refer to a measure of surface feature variation in the x- and y-directions, i.e., in the plane of the substrate, as discussed further below.

Embodiments of the present disclosure relate to articles and methods of forming such articles that include a glass, glass-ceramic, or ceramic substrate with a thin SiOₓ coating positioned in a pattern on a portion of an anti-glare surface of the substrate for planarizing the anti-glare surface in the desired area. In embodiments, inkjet printing is used to pattern the SiOₓ materials onto the desired area in a manner that results in planarization of the anti-glare surface, resulting in a solution coated glass like coating on at least a portion of the anti-glare surface. The use of inkjet printing is advantageous because it provides a precision pattern coating method that is non-contact and scalable for manufacturing. The use of inkjet printing also enables mask-less patterning of the coating materials, which is a desirably reduces material waste. Once deposited on the anti-glare surface, the SiOₓ materials can be cured thermally or by plasma with and/or without catalyst. The SiOₓ materials provide a low modulus, near-pristine surface with hydroxyl groups for good bonding to the substrate. The cured SiOₓ coating provides planarization of anti-glare surface in the desired area.

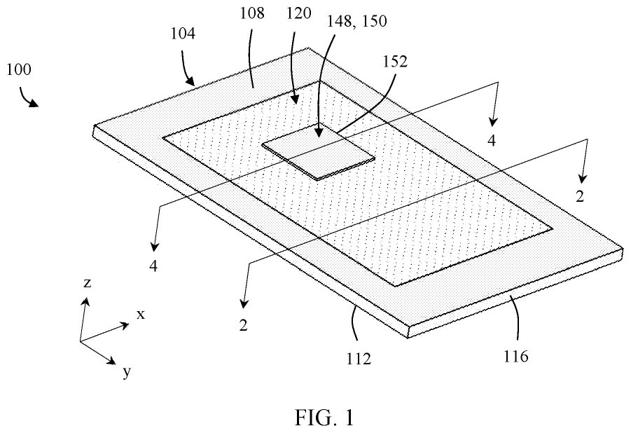

FIGS. 1-8 depict an article 100 according to embodiments of the present disclosure. The article 100 includes a substrate 104 that includes a glass, glass-ceramic, or ceramic composition. The article can have the form of a planar sheet or panel having two major surfaces 108, 112 joined at the periphery by at least one edge 116. The substrate 104 in embodiments can have other shapes such as a three-dimensional shape.

In embodiments, the substrate 104 can be transparent to at least one wavelength in a range from about 390 nm to about 700 nm. In embodiments, the substrate 104 can transmit at least 70%, at least 75%, at least 80%, at least 85%, or at least 90% of at least one wavelength in a range from about 390 nm to about 700 nm. In embodiments, substrate 104 can be a nontransparent material.

The substrate 104 can have any composition that is suitable for the desired article of which the substrate 104 is a component. In embodiments, the substrate 104 can be formed from a glass composition that includes borosilicate glass, aluminosilicate glass, soda-lime glass, alkali aluminosilicate glass, or alkali aluminoborosilicate glass, although other categories of substrates are contemplated, such as those including alkaline earth oxides.

In embodiments, the substrate 104 includes a glass-ceramic material having both a glassy phase and a ceramic phase. Illustrative glass-ceramics include those materials where the glass phase is formed from a silicate, borosilicate, aluminosilicate, or boroaluminosilicate, and the ceramic phase is formed from β-spodumene, β-quartz, nepheline, kalsilite, or carnegieite. “Glass-ceramics” include materials produced through controlled crystallization of glass. Examples of suitable glass-ceramics may include Li₂O—Al₂O₃—SiO₂ system (i.e., LAS-System) glass-ceramics, MgO—Al₂O₃—SiO₂ system (i.e., MAS-System) glass-ceramics, ZnO×Al₂O₃×nSiO₂ (i.e., ZAS system), and/or glass-ceramics that include a predominant crystal phase including β-quartz solid solution, β-spodumene, cordierite, and lithium disilicate. The glass-ceramic substrates may be strengthened using a chemical strengthening process.

In some embodiments, the substrate 104 includes a ceramic material such as inorganic crystalline oxides, nitrides, carbides, oxy nitrides, carbo nitrides, and/or the like. Illustrative ceramics include those materials having an alumina, aluminum titanate, mullite, cordierite, zircon, spinel, perovskite, zirconia, ceria, silicon carbide, silicon nitride, silicon aluminum oxynitride, or zeolite phase.

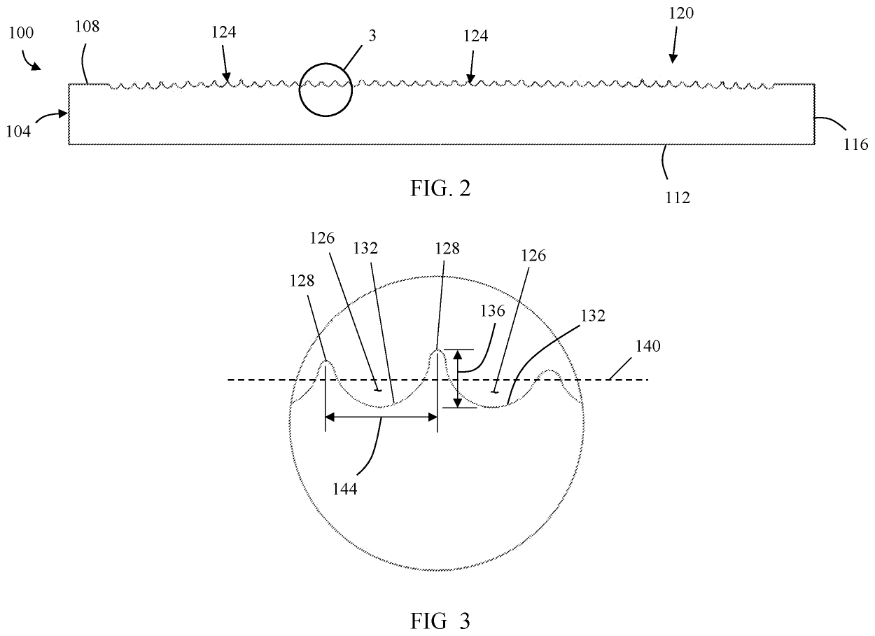

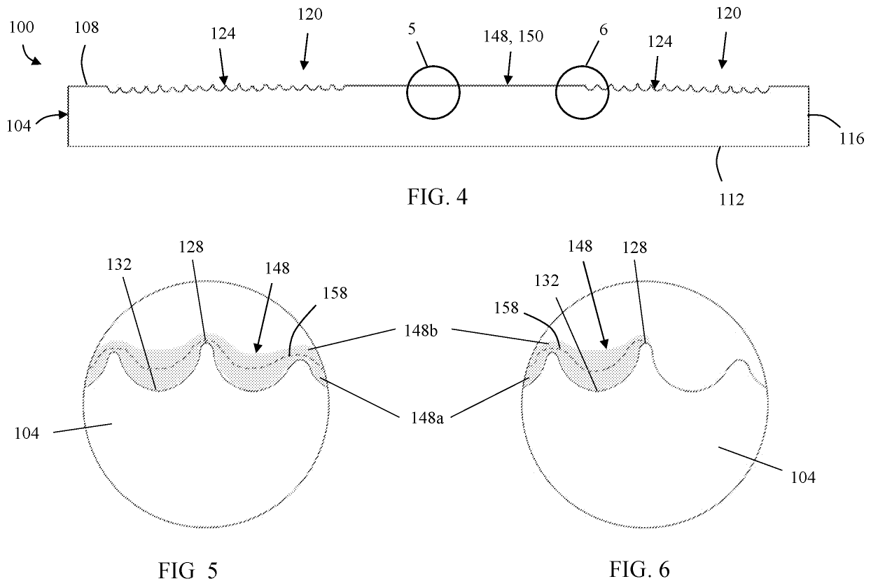

At least one of the major surfaces 108, 112 of the substrate 104, such as a first surface 108, has a roughened or textured region 120 that includes, for example, a plurality of topographical features 124 (FIGS. 2 and 4), such as, projections, protrusions, depressions, pits, islands, lands, trenches, fissures, crevices, and like geometries and features, or combinations thereof. In embodiments, the textured region 120 can cover an area less than the area of the major surface 108 on which it is disposed, as shown in FIG. 1, or an area equal to the area of the major surface 108.

The textured region 120 in embodiments can be an anti-glare surface as defined herein. The textured region 120 of the article 100 has at least one surface attribute from a group of surface attributes that includes a desired transmission haze, distinctness-of-image (DOI), roughness, and abrasion resistance. The topographical features 124 of the textured region 120 can have one or more feature attributes configured to realize the at least one surface attribute. The feature attributes can include, for example, a feature shape, spacing, width, depth, aspect ratio, and like attributes that describe the structure of the topographical features and their spatial relationships to one another on the substrate 104. It will be appreciated that topographical features produced by different surface treatment processes can have similar or different feature attributes.

Referring now to FIGS. 2-6, conceptual cross-sectional cut views taken through line 2-2 (FIGS. 2 and 3) and line 4-4 (FIGS. 4-6) of FIG. 1 are depicted. The topographical features 124 in the illustrated embodiment are generally define approximately partial spherical or ellipsoid voids 126 that open towards the surface 108. With this morphology, the topographical features 124, when viewed at a cross-section, provide peaks 128 and valleys 132. The distance between one of the peaks 128 and one of the valleys 132 of the topographical feature 124 is a height 136 of the topographical feature 124. The height 136 of a topographical feature 124 can be measured. The arithmetic average of the absolute values of the height deviations from a mean line 140, taken along a profile (line) (such as line 2-2), is referred to as the “average surface roughness” and is symbolized as “Ra.” Since Ra is determined based on deviation from a mean line 28 between the peaks 128 and the valleys 132 of all the topographical features 124 along the line, the Ra is approximately half of the average peak to valley heights 136 of all the topographical features 124 along the line. The average surface roughness Ra for the textured region 120 of the substrate 104 can be determined using known techniques and devices, for example, commercially available optical profilers. It should be understood that the other of the major surfaces 108, 112 of the substrate 104, such as a second surface 112, can also have a textured region with topographical features 124.

Similar to the height 136 of the topographical feature 124, an average width 144 at respective entrance portions of the topographical features 124 can be measured. With the type of morphology of the embodiment illustrated in FIGS. 2-6, the width 144 of any given topographical feature 124 is the distance between one peak 128 and the adjacent peak 128 (which approximates a diameter of the topographical feature 124). In some instances, the width 144 of any given topographical feature 124 can be the distance between one valley 132 and the next adjacent valley 132. Since the width 144 of a topographical feature 124 is measured in the plane of the respective surface 108, 112 on which it is arranged, the width 144 is independent of the height 136 of the topographical feature 124 (and thus the width 144 is independent of the average surface roughness, Ra).

A standard calibrated optical light microscope or AFM can typically be used to measure the width 124 of a topographical feature 124. Different methods of measuring the width 144 of the topographical feature 124 can be utilized. The method of average characteristic largest feature size (abbreviated “ALF”) is the average x-y linear dimension of the twenty largest repeating topographical features 124 within a viewing field on the surface 108 that has been textured. The viewing field is proportional to the topographical feature 124 size, and typically has an area of approximately 30(ALF)×30(ALF). If, for example, the ALF is approximately 10 μm, then the viewing field from which the twenty largest topographical features 124 are selected is approximately 300 μm×300 μm. The standard deviation of the twenty largest topographical features 124 that are used to determine ALF should generally be less than about 40% of the average value, i.e., major outliers should be ignored since these are not considered “characteristic” features. In the case of the textured region 120 having the appearance of a cellular matrix, for example, the topographical features 124 to be measured in the ALF determination are the largest of the cells (circular-like peaks 128) in the cellular matrix. The ALF method is preferred over other methods that determine a more global average feature size, because the human eye most easily sees the largest topographical features 124 and are therefore most important in determining visual acceptance of the substrate 104. However, other methods that determine a more global average topographical feature 124 size can be utilized to determine the average width 144 of the topographical features 124. The ratio of height-to-width of the topographical features 124 (also known as the aspect ratio) can be calculated as 2 Ra/ALF.

In embodiments, the topographical features 124 are separated from each other or spaced apart at a mean distance ranging from about 10 nm to about 200 nm though other mean distances are possible. The average width of the voids 126 defined by the topographical features 124 at the entrance portion thereof can be in a range of from about 1 μm to about 400 μm, or from about 2 μm to about 300 μm, or from about 3 μm to about 200 μm, or from about 4 μm to about 100 μm, or from about 5 μm to about 75 μm.

The topographical features 124 can have an average height from the entrance portion or an average height, for example, from a bottom or lowest point of each depression to a top or highest point of an adjacent projection. The average height can be in range from about 10 nm to about 10 μm, or from about 100 nm to about 5 μm, or from about 100 nm to about 4 μm, or from about 100 nm to about 2 μm. The textured region 120 can have an average roughness (Ra), as measured by the peak to valley difference (PV) measured on the surface. In embodiments, the textured region 120 has a root mean square (RMS) roughness, “Rq” of about 800 nm, of about 500 nm, or of about 100 nm.

Referring now to FIGS. 1 and 4-8, the article 100 further includes a coating 148, 150 comprising a cured silicon oxide (SiOₓ) material positioned in a pattern 152 on at least a portion of the textured region 120. As used herein, a “pattern” refers to a predetermined and/or predefined area or region on and above the surface within which the coating is configured to occupy. The pattern typically has an outer periphery within which the coating is positioned on and above the surface. The pattern can also have an inner periphery such that the coating is positioned on and above the surface between the inner and outer peripheries. The inner and/or outer peripheries of the pattern can have any geometric shape and can be continuous and/or discrete as describe later in this disclosure. An area or region of coating that results from the arbitrary positioning of the coating on the surface is not a pattern.

As used herein, “SiO % material” refers to materials that include silicon-oxygen bonded compounds. In embodiments, the silicon-oxygen compounds are represented by the formula SiOₓ, where 0.5≤x≤3. The SiOₓ material can further include organic or inorganic compounds bonded to the silicon-oxygen compounds. The SiOₓ material preferably includes hydroxyl groups (OH⁻) so as to form silanol with the connectively Si—O—H, which can result from reactions with the organic or inorganic compounds. Silanol can be beneficial so as to promote good bonding to the substrate 104.

In an exemplary embodiment, the SiOₓ material is silsesquioxane, an organosilicon compound with the chemical formula [RSiO_{3/2}]ₙ, where R is H or an organic moiety such as an alkyl, aryl, or alkoxyl group. In embodiments, the silsesquioxane material is a polyhedral oligomeric silsesquioxane material (also referred to as POSS). In embodiments, the silsesquioxane material can have a cage-like or polymeric structure having Si—O—Si linkages and tetrahedral Si vertices. In some examples, the silsesquioxane may form 6, 8, 10, or 12 silicon vertices in which each silicon center is bonded to three oxo groups, which in turn connect to other silicon centers. An exemplary silsesquioxane material is hydrogen silsesquioxane (HSQ) in which R is a hydrogen.

The SiOₓ material of the present disclosure encompasses materials that possess a variety of mechanical and optical attributes as described herein. Some aspects of the present disclosure utilize the SiOₓ material in its liquid state whereas other aspects of the present disclosure utilize the SiOₓ material in its cured state. Attributes associated with use of the SiOₓ material in its liquid state are described later in this disclosure in connection with a method of forming the article 100 via inkjet printing with a liquid solution comprising the SiOₓ material and other constituents.

The coating 148, 150 with the cured SiOₓ material is configured to provide a low modulus, near-pristine surface on the texture region 120 within the pattern 152. The coating 148, 150 at least partially fills every void 126 of the textured region 120 within the pattern 152 such that at least some detectable quantity of the coating 148, 150 is positioned in the corresponding voids 126. In embodiments, the coating 148, 150 completely fills at least some of the voids 126 within the pattern 152. Preferably, as best shown in FIGS. 5-8, the coating 148, 150 completely fills all the voids 126 within the pattern 152.

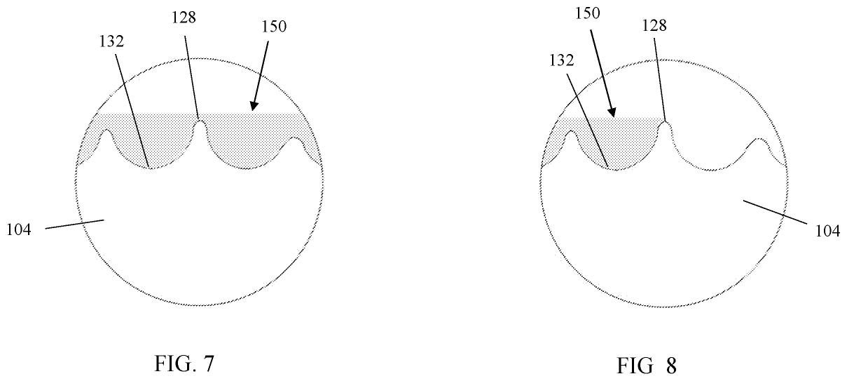

Referring now to FIGS. 5-8, the coating 148 shown in FIGS. 5 and 6 is partially self-leveling while the coating 150 shown in FIGS. 7 and 8 is self-leveling. In the case of the self-leveling coating 150, the term “completely fills” means that a volume of the coating 150 positioned in a respective void equals or exceeds the maximum volume of material the respective void is configured to retain therein without overflowing to an adjacent void. As an illustrative example, using a self-leveling liquid such as water and positioning the substrate such that its major surfaces are normal to the direction of gravity, the maximum volume of a given void would be the maximum volume of water the given void is configured to retain without any overflow of water to an adjacent void. In the case of the partially self-leveling coating 148, the term “completely fills” means that the level of all portions of the coating within a given void equals or exceeds the level associated with the maximum volume of a self-leveling liquid within the given void.

Referring again generally to FIGS. 1-8, the voids 126 of the textured region 120 within the pattern 152 collectively have a volume. The coating 148, 150 in embodiments has a volume that is less than the volume of the voids 126 within the pattern 152. The volume of the coating 148, 152 in other embodiments is approximately equal to the volume of the voids 126 within the pattern 152. In yet further embodiments, the volume of the coating 148, 152 is greater than the volume of the voids 126 within the pattern 152. In the case of the volume of the coating 148, 152 being equal to or greater than the volume of the voids 126, a surface of the coating 148, 152 can be coplanar with the first surface 108 such that the coating 148, 152 fully planarizes the textured region 120 within the pattern 152. The coating 148, 152 is configured to planarize the textured region 120 within the pattern 152 to an extent even when the volume of the coating 148, 152 is less than the volume of the voids 126 within the pattern 152.

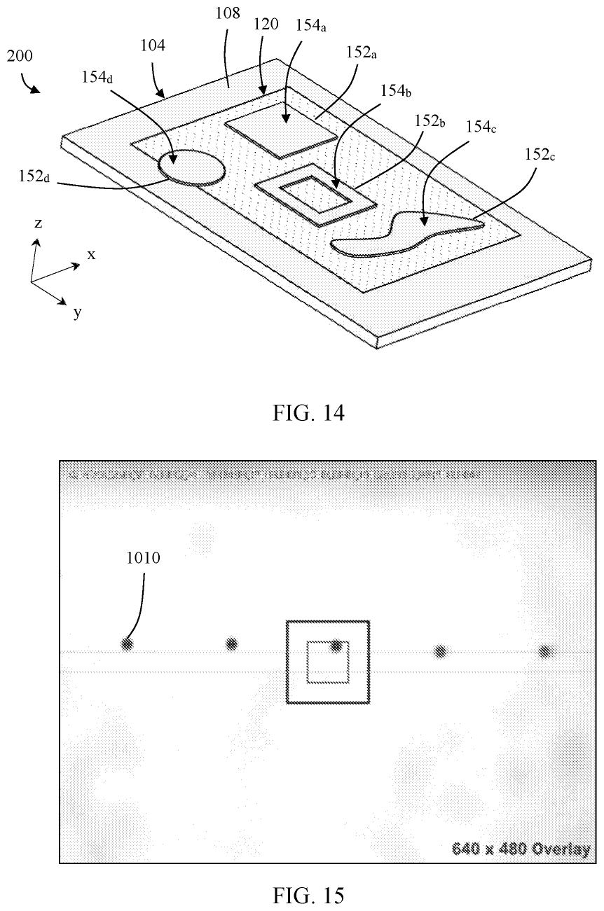

Referring now to FIGS. 1 and 14, the pattern in which the coating 148, 150 is positioned on the portion of the textured region 120 of the substrate 104 can have different configurations. For example, the pattern 152 of the article 100 depicted in FIG. 1 is continuous across the first surface 108 such that the coating 148, 150 forms a single, interconnected coating region positioned on the textured region 120. In embodiments, such as the article 200 shown in FIG. 14, the pattern is discontinuous across the first surface 108 and comprises a plurality of pattern portions 152ₐ, 152_{b}, 152_{c}, 1524 such that the coating 148, 150 forms a plurality of discrete coating regions 154ₐ, 154_{b}, 154_{c}, 154_{d} spaced-apart from one another on the first surface 108. Though the article 200 of FIG. 14 comprises four discrete coating regions 154ₐ, 154_{b}, 154_{c}, 154_{d}, it should be appreciated that the article 200 can include a larger or smaller number of discrete coating regions, for example, two discrete coating regions or six discrete coating regions.

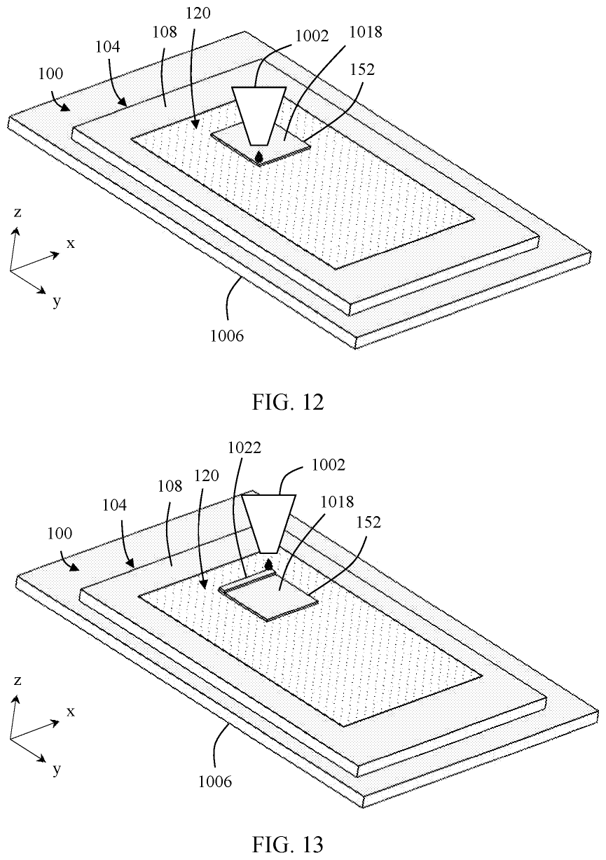

In embodiments, the area of the single pattern 152 or the cumulative area of the pattern portions 152ₐ, 152_{b}, 152_{c}, 152_{d} can be less than an area of the textured region 120 as illustrated in FIGS. 1 and 12. In further embodiments, the area of the single pattern 152 or the cumulative area of the pattern portions 152ₐ, 152_{b}, 1524, 152_{d} can be equal to the area of the textured region 120 such that the coating 148, 150 covers an entirety of the textured region 120. In yet further embodiments, the area of the single pattern 152 or the cumulative area of the pattern portions 152ₐ, 152_{b}, 152_{c}, 152_{d} can be greater than the area of the textured region 120 such that the coating 148, 150 covers the entirety of the textured region 120 and covers a portion or all of the first surface 108 that does not include in the textured region 120.

In embodiments in which the area of the single pattern 152 or the cumulative area of the pattern portions 152ₐ, 152_{b}, 152_{c}, 152_{d} is less than the area of the textured region 120, the single pattern 152 or the pattern portions 152ₐ, 152_{b}, 152_{c}, 1524 are configured to be located at any position on the textured region and are not limited to the positions illustrated in the figures.

In embodiments, the single pattern 152 or the pattern portions 152ₐ, 152_{b}, 152_{c}, 152_{d} can have an outer periphery with any shape. For example, the single pattern 152 of FIG. 1, the first pattern portion 152ₐ of FIG. 14, and the second pattern portion 152_{b} of FIG. 14 each have an outer periphery with a square shape. Similarly, the third pattern portion 152_{c} and the fourth pattern portion 152_{d} of FIG. 14 have an amorphous shape and a circular shape, respectively. The third pattern portion 154 additionally has an inner periphery with the coating 148, 150 disposed between the inner and outer peripheries. Though the inner periphery of the third pattern portion 154 is shown with a square shape, the inner periphery like the outer periphery can have any shape.

Referring again to FIGS. 5-8, the coating 148, 150 in embodiments comprises exactly one layer of the cured SiOₓ material. Additionally, or alternatively, the coating 148, 150 or portions thereof can comprise n layers of the cured SiOₓ material, where n is a positive integer and 1<n<15. In embodiments, the lower limit for n can be greater than 1 and/or the upper limit for n can be lesser or greater than 15, for example, 1<n<14, 1<n<12, 1<n<10, 1<n<7, 2<n<15, 4<n<15, 6<n<15, 9<n<15.1<n<16, 1<n<18, 1<n<20, 2<n<18, 4<n<16, or 6<n<10.

In the embodiment illustrated in FIGS. 5 and 6, the coating 148 comprises two layers, which include a first layer 148a positioned directly on the textured region 120 of the substrate 104 and a second layer 148b positioned directly on the first layer 148a. An interface 158 between the first and second layers 148a, 148b is schematically depicted via a dashed line in FIGS. 5 and 6. Whether or not the interface 158 is visible or otherwise detectible depends on aspects of the method of forming the article as described later in this disclosure. For instance, if the coating 148 is formed by at least partially curing a given layer of the SiOₓ material prior to positioning one or more further layers, an interface 158 between the given layer and the one or more further layers may be visible or otherwise detectible. In embodiments, it is preferable to minimize or eliminate the visibility and/or detectability of interfaces between multiple layers of the coating 148.

The coating 148, 150 can have any desired thickness based on the intended application and/or associated components or features of the article. The coating 148, 150 is configured to be positioned on at least a portion of the textured region 120. Additionally, or alternatively, the coating 148, 150 can be positioned on portions of the major surfaces 108, 112 that are not textured. In embodiments, the coating 148, 150 has a thickness of at least about 10 nm and up to several micrometers (μm) in thickness. For example, the coating 148, 150 can have a thickness of at least 10 nm, at least 15 nm, at least 50 nm, at least 100 nm, at least 500 nm, at least 1 μm, or at least 2 μm. In embodiments, the determination of the thickness of the coating 148, 150 considers the extent of self-leveling of the coating. For example, the determination of the thickness of a coating that is partially self-leveling can include measurement and/or data processing techniques that are different from the determination of the thickness of a coating that is self-leveling. The thickness of the coating can be measured using various known techniques, including destructive and non-destructive techniques.

According to embodiments of the present disclosure, the coating 148, 150 can be characterized by an elastic modulus of from about 9 GPa to about 40 GPa. For example, the intermediate coating 30 can be characterized by an elastic modulus of from about 9 GPa to about 40 GPa, about 10 GPa to about 40 GPa, about 15 GPa to about 40 GPa, about 20 GPa to about 40 GPa, about 30 GPa to about 40 GPa, about 35 GPa to about 40 GPa, about 9 GPa to about 35 GPa, about 10 GPa to about 35 GPa, about 15 GPa to about 35 GPa, about 20 GPa to about 35 GPa, about 30 GPa to about 35 GPa, about 9 GPa to about 30 GPa, about 10 GPa to about 30 GPa, about 15 GPa to about 30 GPa, about 20 GPa to about 30 GPa, about 9 GPa to about 25 GPa, about 10 GPa to about 25 GPa, about 15 GPa to about 25 GPa, about 20 GPa to about 25 GPa, about 9 GPa to about 20 GPa, about 10 GPa to about 20 GPa, about 15 GPa to about 20 GPa, or about 10 GPa to about 15 GPa. In some examples, the intermediate coating 30 can be characterized by an elastic modulus of about 9 GPa, about 10 GPa, about 15 GPa, about 16 GPa, about 17 GPa, about 18 GPa, about 20 GPa, about 30 GPa, about 32 GPa, 33 GPa, about 34 GPa, about 35 GPa, about 39 GPa, about 40 GPa, or any elastic modulus value between these values.

The coating 148, 150 is configured to modify at least one surface attribute of the textured region 120 of the article 100, for example, at least one surface attribute from a group of surface attributes that includes a desired transmission haze, distinctness-of-image (DOI), roughness, and abrasion resistance. The extent to which the relevant surface attribute of the textured region 120 is modified by the positioning of the coating 148, 150 thereon can depend on one or more factors. Such factors can include, for example, the initial value and/or condition of the surface attribute of the textured region 120 before the coating 148, 150 is positioned thereon, the type(s) of SiOₓ material in the coating, the number of layers of the coating and/or the thickness of the coating, and/or the composition of the substrate.

For the surface attribute of transmission haze, the transmission haze of the substrate 104 through the portion of the textured region 120 with the coating 148, 150 is less than the transmission haze through a reference portion of the textured region 120 without the coating 148, 150. In embodiments, the transmission haze through the coated portion is at least 20% less, at least 40% less, at least 60% less, at least 70% less, at least 80% less, or at least 90% less than the transmission haze through the reference portion. In embodiments, the transmission haze through the coated portion of the textured region 120 can be reduced to less than about 15% haze, less than about 12% haze, less than about 10% haze, less than about 6% haze, less than about 5% haze, less than about 3% haze, less than about 2% haze, or even less than about 1% haze. The reduction in transmission haze through the coating 148, 150 generally increases with an increase in the number of layers of the coating and/or an increase in the thickness of the coating. The reduction in transmission haze can have a linear relationship with the increase in coating layers and/or coating thickness. In embodiments, the transmission haze is reduced by at least 2% haze per coating layer, or by 4% haze per coating layer, or even by 6% haze per coating layer.

For the surface attribute of distinctiveness of image (DOI), the DOI of the substrate 104 at the portion of the textured region 120 with the coating 148, 150 is greater than the DOI at a reference portion of the textured region 120 without the coating 148, 150. In embodiments, the DOI at the coated portion is at least 50% greater, at least 60% greater, at least 70% greater, at least 80% greater, at least 85% greater, or at least 90% greater than the DOI at the reference portion. In embodiments, the DOI at the coated portion of the textured region 120 can be increased to a DOI of greater than about 60, greater than about 65, greater than about 70, greater than about 75, greater than about 80, greater than about 82, greater than about 85, or even greater than about 95. The increase in DOI at the coating 148, 150 generally increases with an increase in the number of layers of the coating and/or an increase in the thickness of the coating. The increase in DOI can have a linear relationship with the increase in coating layers and/or coating thickness. In embodiments, the DOI is increased by at least 3 per coating layer, or by 4 per coating layer, or by 5 per coating layer, or even by 6 per coating layer.

For the surface attribute of average surface roughness (Ra), the Ra of the substrate 104 along the portion of the textured region 120 with the coating 148, 150 is less than the Ra along a reference portion of the textured region 120 without the coating 148, 150. In embodiments, the Ra along the coated portion is at least 20% less, at least 40% less, at least 60% less, at least 70% less, at least 80% less, or at least 90% less than the Ra along the reference portion. The reduction in Ra along the coating 148, 150 generally increases with an increase in the number of layers of the coating and/or an increase in the thickness of the coating.

For the surface attribute of abrasion performance, the abrasion performance of the substrate 104 along the portion of the textured region 120 with the coating 148, 150 is greater than the abrasion performance along a reference portion of the textured region 120 without the coating 148, 150. As used herein, an abrasion performance of a first portion that is “greater than” an abrasion performance of a second portion means the first portion is more resistant to abrasion than the second portion. In embodiments, the abrasion performance along the coated portion is at least 50% greater, at least 60% greater, at least 70% greater, at least 80% greater, at least 85% greater, or at least 90% greater than the abrasion performance along the reference portion. In embodiments, the abrasion performance along the coated portion shows less visible scratch compared to the abrasion performance along the reference portion. The increase in abrasion performance along the coating 148, 150 generally increases with an increase in the number of layers of the coating and/or an increase in the thickness of the coating. Without being bound by theory, it is believed there is a reduction in coefficient of friction by planarizing the textured region with the SiOₓ coating. Additionally, by planarizing the textured region, the peaks of the topographical features are protected and less likely to break off and lead to three-body abrasion causing visible damage to the surface.

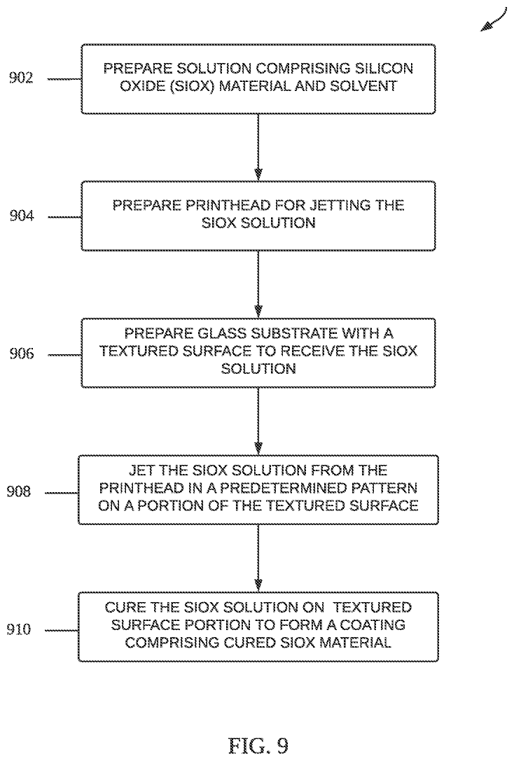

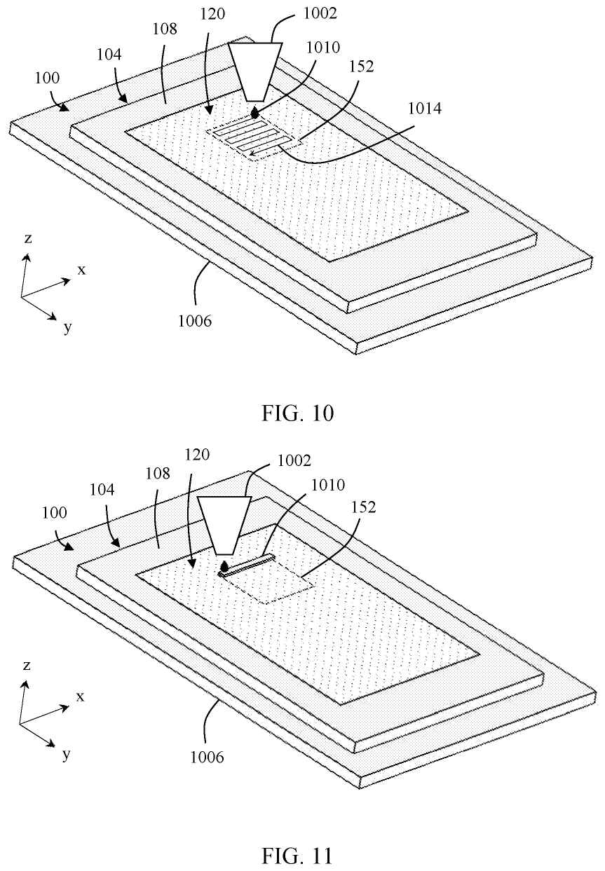

Referring now to FIG. 9, a flow chart is provided to illustrate embodiments of a method 900 of planarizing a textured article, such as the article 100 of FIG. 1, with a SiOₓ coating. The method 900 of FIG. 9 is further described with reference to FIGS. 10-13, which depict a series of top perspective representations of the article aspects of the method 900.

The method 900 in embodiments includes preparing a solution comprising a silicon oxide (SiOₓ) material and a solvent (block 902). The SiOₓ material can be any of the materials described above with reference to FIGS. 1 and 4-8. The SiOₓ material can also include polysilazanes, which are represented by the formula SiNₓ. Polysilazanes can become SiOₓ after curing, which method step is described later in this disclosure. The solution comprising the SiOₓ material and the solvent is interchangeably referred to herein as the SiOₓ solution. The SiOₓ solution is prepared so as to be jetted in a stable manner from a printhead, such as the printhead 1002 depicted in FIGS. 10-13, of a printer (not shown). The printer is preferably an “inkjet” printer though the printer in embodiments can be any printer configured to operate the printhead 1002 to jet the SiOₓ solution in a stable manner. As used herein, “stable jetting,” “jetted in a stable manner,” and/or like terms or phrases means the SiOₓ solution is configured to be jetted in discrete, single drops with no tail, stream, and/or spray (i.e., each drop stays completely intact) during the flight of each drop from the printhead to the surface 108 of the substrate 104 on which the drop is precisely positioned as part of the pattern.

The SiOₓ solution is configured to be jetted onto the substrate 104 as a solvent dispersion. Solvents which can be used include any agent or mixture of agents which will dissolve the SiOₓ material to form a homogeneous liquid mixture without affecting the resulting coating. Such solvents can include alcohols such as ethyl alcohol or isopropyl alcohol; aromatic hydrocarbons such as benzene or toluene; alkanes such as n-heptane, dodecane or nonane; ketones such as methyl iso-butyl ketone; esters; glycol ethers; siloxanes such as cyclic dimethylpolysiloxanes and linear dimethylpolysiloxanes (e.g., hexamethyldisiloxane, octamethyltrisiloxane and mixtures thereof); and others. Other solvents can include perfluoroalkane and fluoroether solvents and fluorinated solvents such as 3M Novec series (e.g., HFE7200) and 3M Fluorinert series (e.g., FC-40).

The solvent is present in an amount sufficient to dissolve the SiOₓ material to the concentration desired for application. In embodiments in which the SiO % material is hydrogen silsesquioxane (HSQ), the solvent can be 3-methoxy-3-methyl-1-butanol (MMB) and the HSQ is diluted in the MMB at a concentration of from about 2.5 wt % to about 5 wt %, based on a total weight of the solution. Subsequent to diluting the SiOₓ material in the solvent, preparing the SiOₓ solution can further comprise mixing the solution for a given time and filtering the mixed SiOₓ solution through a filter to form the stably jettable SiOₓ solution.

The SiOₓ solution is configured to have a target viscosity and a target surface tension that enable the stable jetting from the printhead. The target viscosity in embodiments is in a range from about 8 cP to about 12 cP. In embodiments, the target viscosity can have a different range, for example, a wider range from about 6 cP to about 14 cP, or from about 4 cP to about 16 cP, or even from about 2 cP to about 18 cP. The target viscosity in embodiments can have a shifted range or a narrower range. The target surface tension in embodiments is in a range from about 25 mN/m to about 32 mN/m. In embodiments, the target surface tension can have a different range, for example, a wider range from about 23 mN/m to about 34 mN/m, or from about 21 mN/m to about 36 mN/m, or even from about 19 mN/m to about 38 mN/m. The target surface tension in embodiments can have a shifted range or a narrower range. One or more of the target viscosity and the target surface tension is configured to be compatible with the printhead 1002.

The method 900 further comprises preparing the printer and/or the printhead 1002 for jetting the SiOₓ solution (block 904). Aspects of this step can include transferring the filtered SiOₓ solution to the printhead 1002, placing the printhead 1002 in the printer, and setting the printhead parameters. The printhead parameters can include, for example, one or more of a peak voltage, a printhead temperature, and a drive waveform. In embodiments, the peak voltage is approximately 20V, the printhead temperature is approximately 35° C., and the drive waveform is a standard waveform. It should be appreciated that other printhead parameters are possible as long as the SiOₓ solution can be jetted from the printhead 1002 in a stable manner.

The method 900 further comprises preparing a substrate to receive the jetted SiOₓ solution (block 906). The substrate can have the shape, composition, and anti-glare features as the substrate 104 of FIG. 1 prior to coating, so reference will be made to the substrate 104 hereinafter. The substrate 104 can be mounted to a support 1006 configured to retain the substrate 104 thereon. The support 1006 in embodiments can be mounted to a motion translation stage (not shown) configured for movement in any of the x-, y-, and z-directions depicted in the figures.

In embodiments, preparing the substrate 104 to receive the jetted SiOₓ solution can further include removing organics from the first major surface 108 of the substrate 104, for example, by treating the first major surface 108 with oxygen plasma. In embodiments, preparing the substrate 104 to receive the jetted SiOₓ solution can further include preheating the substrate 104 to a target temperature. The target temperature in embodiments is at least room temperature, for example, at least about 20° C. In embodiments, the target temperature can be a temperature in a range of from greater than about 20° C. to about 65° C.

Referring now to FIGS. 9-13, the method 900 further comprises jetting the SiOₓ solution from the printhead 1002 in a pattern 152 on at least a portion of the textured region 120 of the substrate 104 (block 908). The printhead 1002 is configured to jet the SiOₓ solution as a series of discrete drops 1010 along a print path 1014 (FIG. 10) to position the SiOₓ solution within the pattern 152 (FIG. 11). The print path 1014 is selected such that the jetted SiOₓ solution forms at least one layer throughout the area defined by the pattern 152, such as the first layer 1018 of SiOₓ solution shown in FIG. 12. The print path 1014 depicted in FIG. 10 is serpentine-like though in embodiments the print path 1014 can have any shape along which the printhead can be moved relative to the substrate 104. Additionally, or alternatively, the support 1006 with the substrate 104 retained thereon can be moved via the motion translation stage so as to move the substrate 104 relative to the printhead along the print path 1014. The rate of relative movement between the printhead 1002 and the substrate corresponds to a print speed of the printhead 1002. The print speed in an exemplary embodiment is approximately 200 mm/s though the print speed in embodiments can be greater or lesser than 200 mm/s.

In embodiments, the SiOₓ solution can be jetted in exactly one layer throughout the pattern 152. As an example, FIG. 12 illustrates the printhead 1002 about to complete the jetting of the first layer 1018 of the SiOₓ solution on the textured region 120 of the substrate 104. If no further layers of the SiO solution are jetted on the first layer 1018, the resulting article will have exactly one layer of the SiOₓ solution jetted throughout the pattern 152.

In embodiments, the SiOₓ solution can be jetted in n layers throughout the pattern 152, where n is a positive integer, such as described above with reference to FIGS. 5-8. As an example, FIG. 13 illustrates the printhead 1002 jetting a portion of a second layer 1022 of the SiOₓ solution on the first layer 1018, which was already jetted on the textured region 120. In embodiments in which the SiOₓ solution is jetted in more than one layer, one or more of the printhead 1002 and the support 1006 is configured to be moved in the z-direction to increase a distance between the printhead 1002 and the jetted SiOₓ solution on the substrate 104.

The jetting of the SiOₓ solution in a layer throughout the pattern 152 can be referred to as a pass or a print pass. For instance, the first layer 1018 of the SiOₓ solution can be jetted on the textured region 120 during a first pass of the printhead 1002 and the second layer 1022 of the SiOₓ solution can be jetted on the first layer 1018 during a second pass of the printhead 1002.

In embodiments, each drop 1010 of the SiOₓ solution jetted from the printhead 1002 has a drop volume in a range from about 1 pL to about 20 pL, or from about 5 pL to about 15 pL, or from about 8 pL to about 12 pL. The drop volume in an exemplary embodiment is about 10 pL. The printhead 1002 in embodiments includes a piezo driver that is responsive to the printhead parameters, such as the drive waveform and the peak voltage, to jet the SiOₓ solution as described herein. It will be appreciated that other printheads with other drivers can be used to jet the SiOₓ solution.

In embodiments, the printhead 1002 can be configured to jet the discrete drops of the SiO solution in the pattern 152 with a target resolution in a range of from about 600 dpi to about 1200 dpi. In embodiments, the target resolution can be larger or smaller, for example, the target resolution can be in a range from about 300 dpi to about 1500 dpi or from about 800 dpi to about 1000 dpi. The target resolution in an exemplary embodiment is approximately 1200 dpi. In embodiments, the printhead 1002 can have different target resolutions for jetting different passes of the SiOₓ material. For example, the printhead 1002 can have a first target resolution for jetting the SiOₓ solution during a first pass and a second target resolution for jetting the SiOₓ solution during a second pass with the first and second target resolutions being different from one another.

The method 900 further includes curing the SiOₓ solution after jetting to form a coating 148, 150 comprising the cured SiOₓ material (block 910). In embodiments in which the SiOₓ solution is jetted in more than one layer on the textured region 120, curing the SiOₓ solution can include curing each layer of the n layers of the SiOₓ solution after each layer is jetted from the printhead 1002. The interface 158 between the layers may be visible or otherwise detectable when the n layers are cured after jetting each layer. Still referring to embodiments in which the SiOₓ solution is jetted in more than one layer on the textured region 120, curing the SiOₓ solution can include curing the SiOₓ solution after jetting all the n layers of the SiOₓ solution from the printhead 1002. In this latter approach, the interface 158 between the layer may less visible or not visible or otherwise detectable.

In embodiments, curing the SiOₓ solution can comprise thermal curing. For example, the SiOₓ solution can be thermally cured to an insoluble coating by heating the SiOₓ solution for a sufficient time at a temperature of from about 150° C. to about 800° C., or from about 200° C. to about 700° C., or from about 250° C. to about 600° C., or even from about 400° C. to about 600° C. As used herein, “insoluble coating” means a coating that is essentially not soluble in the solvent from which the SiOₓ was jetted to form the SiOₓ coating or any solvent disclosed above herein as being useful for the application of the SiOₓ solution.

Any method of heating such as the use of a convection oven, rapid thermal processing, hot plate, or radiant of microwave energy may be used herein. The method used should be capable of rapidly heating the film to the desired temperature.

The duration of time that the coating is heated to cure will depend on the environment during the heating, the temperature at which it is heated (soak temperature), the rate at which it is heated and the thickness of the SiOₓ solution. At higher soak temperatures and/or higher concentrations of oxygen in the cure environment the cure time will be shorter. In embodiments, the SiOₓ solution is heated from about 1 second to about 4 hours, or from about 1 minute to about 3 hours, or from about 30 minutes to about 2 hours.

In embodiments, curing the SiOₓ solution can comprise plasma curing. The plasma curing can be performed with or without a catalyst when useful. The plasma curing when coupled with a catalyst can reduce the cure duration and/or the cure time depending on the catalyst.

### Example

The following example further clarifies the various embodiments disclosed herein.

### Experimental Procedure

AG glass coupons measuring 100 mm×100 mm and textured to either 20% haze or 40% haze were prepared as substrates. Prior to applying the SiOₓ coating, the substrates were treated with oxygen plasma (200 W, 1.5 torr, 3639 ccm) using a Branson plasma chamber for 5 min to remove organics from the surface.

The printhead used in the experiment was a piezo driven printhead with a 10 pL drop volume (Fuji Dimatix DMC 11610). This printhead is compatible with inks having viscosities in a range from about 8 cP to about 12 cP and surface tensions in a range from about 25 mN/m to about 32 mN/m. To inkjet print the SiOₓ material, a compatible solvent was selected to enable the viscosity and surface tension values configured for stable jetting from the drop on demand, piezo-electric nozzle of the printhead. Hydrogen silsesquioxane (HSQ Fox 25, Dow Chemical) was diluted in 3-methoxy-3-methyl-1-butanol (MMB, Sigma Aldrich) at a concentration of 2.5 wt %-5 wt % and placed in an ultrasonic bath for 10 min to mix. The mixture was then filtered to provide the printable HSQ solution.

The HSQ solution was transferred to the printhead. The printhead was then placed in a Pixdro LP 50 inkjet printer from Meyer Burger. The printhead temperature was set at 35° C. The standard waveform was used with a peak voltage of 20-21 V. The stable jetting of the HSQ solution from the printhead is illustrated FIG. 15, which shows an image overlay of a portion of the flight of at least one drop 1010 of the HSQ solution form the printhead. The flight of the drop 1010 is shown traveling horizontally relative to the orientation of the view of FIG. 15 at five sequential positions during the flight. Stable jetting is achieved since the drop 1010 of the HSQ solution does not exhibit a tail, stream, and/or spray during the flight.

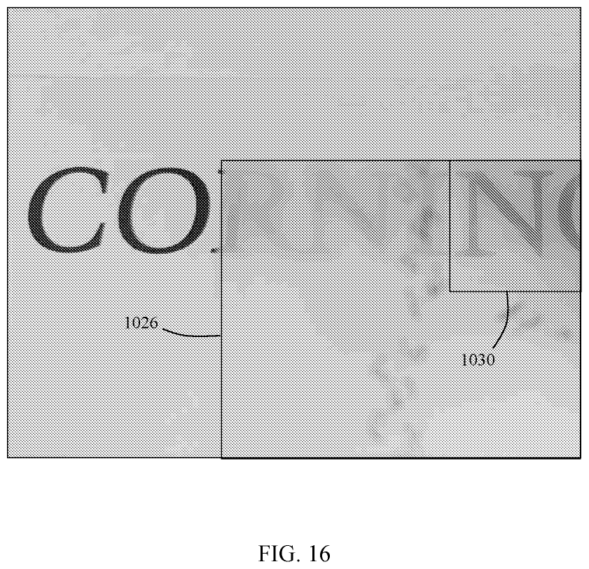

Squares of the HSQ solution having different sizes (e.g., 10 mm×10 mm squares, 100 mm×100 mm squares, and sizes in between those squares) were printed on the AG glass coupons at a resolution in a range from about 600 dpi to about 1200 dpi and at a print speed of 200 mm/s. The substrate temperature was set at 55° C. Following printing, the HSQ solution-coated samples were thermally cured in a range of from about 400° C. to about 600° C. For samples in which the HSQ solution was applied in multiple layers, some of the samples were additionally plasma cured in between the print passes. 101371 FIG. 16 is an image of a glass substrate 1026 with an anti-glare surface having 20% haze with a portion of the anti-glare surface including a SiOₓ coating 1030. The glass substrate 1026 is positioned to overlay a string of text to illustrate the reduction in haze over the SiOₓ coated portion 1030 of the glass substrate. When viewed through the inkjet-printed SiOₓ coating 1030, the second “N” in the text string appears sharper compared to the first “N”.

### Measurements and Test Data

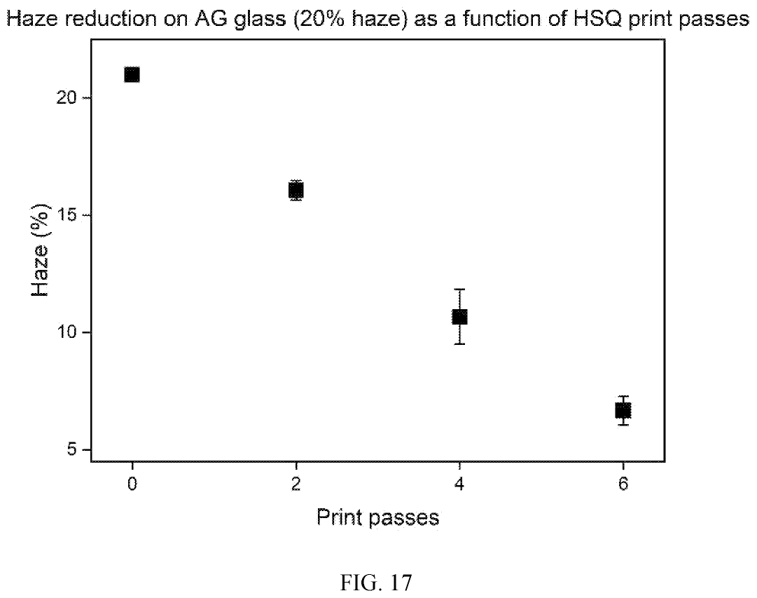

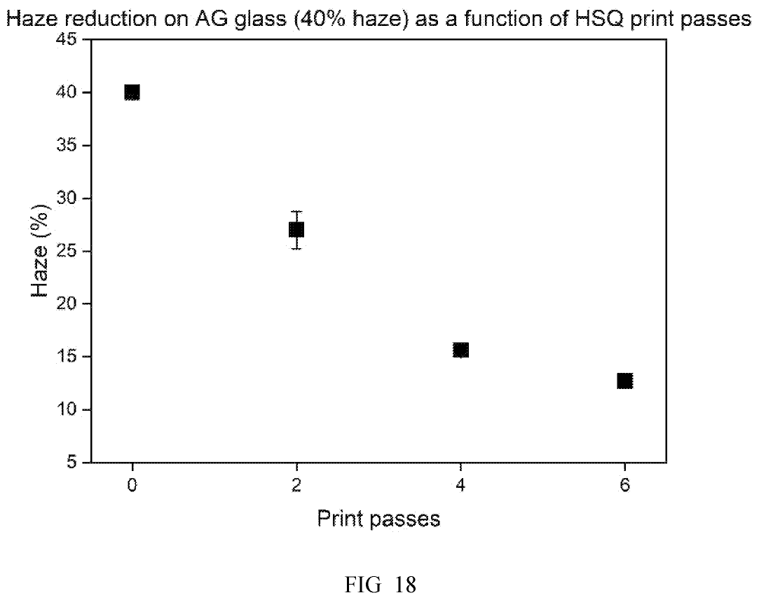

The samples were characterized for haze, DOI and abrasion performance after curing the HSQ solution. The haze of the samples coated with the cured HSQ was measured using BYK haze-gard dual according ASTM D1003. FIG. 17 shows the % haze reduction in AG samples with 20% haze. The haze decreases from approximately 20% to approximately 6% with 6 print passes with a resolution of 1200 dpi. FIG. 18 shows the % haze reduction in AG samples with 40% haze. The haze decreases from approximately 40% to approximately 12% with 6 printing passes with a resolution of 1200 dpi.

The uncoupled DOI was measured using the Rhopoint instrument according to ASTM D523. The DOI was measured for the samples with 6 print passes both for 20% and 40% haze samples before and after printing. The DOI for the 20% haze samples without any coating was approximately 52 whereas the DOI for the samples with HSQ coating was between 79 and 82. The DOI for the 40% haze samples was 38% whereas the DOI for the samples with the HSQ coating was between 71 and 73.

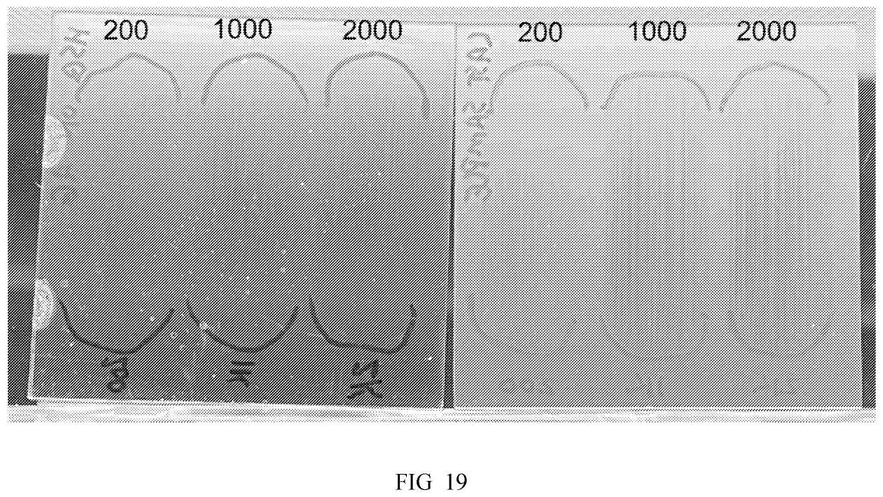

The abrasion test of the samples were carried out using CS8 jumbo as abradant (considered as an aggressive abradant) using a Taber abrader. The test condition was CS8 jumbo, 270 g, 60 cycles/min, 1 inch long stroke length and three tracks (200, 1000, and 2000 cycles). FIG. 19 shows that the HSQ coating improves the abrasion performance of the textured surface. The HSQ coated 40% AG surface (left sample) shows less visible scratch than the reference AG surface without the HSQ coating (right sample) at 200, 1000, and 2000 CS8 abrasion cycles.

While the disclosure has been illustrated and described in detail in the drawings and foregoing description, the same should be considered as illustrative and not restrictive in character. It is understood that only the preferred embodiments have been presented and that all changes, modifications and further applications that come within the spirit of the disclosure are desired to be protected.

1. An article, comprising:
a glass, glass-ceramic, or ceramic substrate having a surface with a textured region, the textured region comprising a plurality of topographical features that define voids opening towards the surface; and
a coating comprising a cured silicon oxide (SiOₓ) material positioned in a pattern on at least a portion of the textured region to fill the voids at least partially.

2. The article of claim 1, wherein the coating completely fills at least some of the voids within the pattern.

3. The article of claim 1, wherein the coating completely fills all the voids within the pattern.

4. (canceled)

5. The article of claim 1, wherein a volume of the coating is less than a volume of the voids within the pattern.

6. The article of claim 1, wherein a volume of the coating is approximately equal to a volume of the voids within the pattern.

7. The article of claim 1, wherein a volume of the coating is greater than a volume of the voids within the pattern.

8. The article of claim 1, wherein the pattern is continuous across the surface such that the coating forms a single, interconnected coating region.

9. The article of claim 1, wherein the pattern is discontinuous across the surface such that the coating forms a plurality of discrete coating regions spaced-apart from one another.

10. (canceled)

11. The article of claim 1, wherein the coating comprises n layers of the cured SiOₓ material, where n is a positive integer and 1<n<15.

12. The article of claim 1, wherein a transmission haze of the substrate through the portion of the textured region with the coating is less than the transmission haze through a reference portion of the textured region without the coating.

13. The article of claim 12, wherein the transmission haze through the coated portion is at least 20% less than the transmission haze through the reference portion.

14. (canceled)

15. The article of claim 1, wherein a distinctiveness of image (DOI) of the substrate at the portion of the textured region with the coating is greater than the DOI at a reference portion of the textured region without the coating.

16. The article of claim 15, wherein the DOI at the coated portion is at least 50% greater than the DOI at the reference portion.

17. (canceled)

18. (canceled)

19. The article of claim 1, wherein an abrasion performance of the substrate at the portion of the textured region with the coating is greater than the abrasion performance at a reference portion of the textured region without the coating.

20. The article of claim 19, wherein the abrasion performance at the coated portion shows less visible scratch compared to the abrasion performance at the reference portion.

21. The article of claim 1, wherein the SiOₓ material includes silicon-oxygen compounds represented by the formula SiOₓ, where 0.5≤x≤3.

22. A method of planarizing a textured article, comprising:
jetting, in a stable manner from a printhead, a solution comprising a silicon oxide (SiOₓ) material and a solvent on a glass, glass-ceramic, or ceramic substrate having a surface with a textured region, the solution jetted in a pattern on a portion of the textured region,
wherein one or more of:
the solution is configured to have a target viscosity and a target surface tension that enable the stable jetting from the printhead, and the target viscosity is in a range from about 8 cP to about 12 cP and the target surface tension is in a range from about 25 mN/m to about 32 mN/m, and
the SiOₓ material includes silicon-oxygen compounds represented by the formula SiOₓ, where 0.5≤x≤3 or compounds configured to be converted to the silicon-oxygen compounds represented by the formula SiOₓ via curing.

23. (canceled)

24. (canceled)

25. (canceled)

26. The method of claim 22, wherein one or more of:
the SiOₓ material is hydrogen silsesquioxane (HSQ) and the concentration of HSQ is from about 2.5 wt % to about 5 wt %, based on a total weight of the solution, the solvent is selected from the group consisting of alcohols, aromatic hydrocarbons, alkanes, ketones, esters, glycol ethers, siloxanes, fluorinated solvents, perfluoroalkane, fluoroether, and combinations thereof, and
the solution is jetted in the pattern with a resolution of at least 600 dpi.

27. (canceled)

28. (canceled)

29. (canceled)

30. (canceled)

31. (canceled)

32. (canceled)

33. The method of claim 22, further comprising heating the substrate to a target temperature of at least 20° C. before jetting the solution on the portion of the textured region.

34. (canceled)

35. (canceled)

36. (canceled)

37. (canceled)

38. The method of claim 22, further comprising curing the solution after jetting to form a cured SiOₓ material or a cured coating comprising the cured SiOₓ material,
wherein the solution is jetted in n layers throughout the pattern, where n is a positive integer and 1<n<15, and
wherein the solution is cured after jetting (each layer of the n layers or (ii) all the n layers.

39. (canceled)

40. (canceled)

41. (canceled)

42. (canceled)

43. (canceled)

44. (canceled)
